(19) United States
(12) Patent Application Publication
(10) Pub. No.: US 2007/0187915 A1
(43) Pub. Date: Aug. 16, 2007

(54) CART FOR CARRYING A TOOL HAVING A PLATE-SHAPED BASE

(76) Inventor: Denis Filiatrault, St-Polycarpe (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/626,801

(22) Filed: Jan. 24, 2007

Related U.S. Application Data
(60) Provisional application No. 60/761,348, filed on Jan. 24, 2006.

(30) Foreign Application Priority Data
Jan. 24, 2006 (CA) CA 2,533,704

(51) Int. Cl. B62B 1/00

(52) U.S. Cl. 280/47.131

(57) ABSTRACT

A wheeled cart for carrying a tool is provided. This wheeled card is suitable for carrying tools having a plate base, such as vibrating plate compactors. The wheeled cart comprises a platform on which the tool is laid down, a wheel assembly connected to the platform, and at least one adjustable attach member to removably attach the tool to the platform. The attach member comprises a vertical projecting member extending generally upwardly from the platform and a right-angle bracket. The bracket is removably fastenable to the vertical projecting member at a plurality of longitudinal positions therealong, to adjust to different sizes of tools being transported by the cart.

### CROSS-REFERENCE TO RELATED APPLICATIONS

This application claims priority to U.S. Provisional Application 60/761,348 filed on Jan. 24, 2006.

### BACKGROUND OF THE INVENTION

1. Field of the Invention

The present invention generally relates to an apparatus used to transport of a vibratory plate compactor or a similar tool having a plate-shaped base from one location to another. More particularly, it relates to an apparatus that can be removably attached to a vibratory plate compactor or the like to facilitate its transport.

2. Description of the Related Art

Vibratory plate compactors are designed for compaction of materials and soils in construction, landscaping, paving and structures areas, more particularly in confined areas near sites such as parking lots, highways, railroads, airports, foundations, walls, curbs, slab bases, gutters, trenches, bridges, barrages and fortifications. Applications include compaction of, granular and mixed, cohesive and non cohesive materials, including earth, gravel and sand. These machines are used predominantly for compacting and levelling soil, sand and asphalt during site, road and pavement work.

Vibratory plate compactors are used extensively by ground workers in the construction industry. These compactors typically comprise an engine and an arm, both mounted on a heavy base plate. An operator usually uses the arm to position and manoeuvre the compactor plate, while the engine transmits vibrations to the plate which compacts the surface underneath it.

Use of compactors can vary from a few minutes to several hours. However, when the machine is not being operated, plate compactors are heavy and difficult to move from one location to another. Consequently, operators are sometimes subject to injuries, when attempting to move the compactors over long distances. Back injuries contribute significantly to the total amount of workers injury claims in the related industries. Any device that can help reduce the occurrences of back injuries is desirable.

Certain prior art devices have been developed to address these problems.

U.S. Pat. No. 4,367,880 (HARDING) teaches the use of a support on rollers removably attachable to the base of certain types of heavy machinery tools to facilitate their transport. The machinery must be placed on the support and then tilted to allow displacement of the tool.

U.S. Pat. No. 6,561,745 (ROUNTREE) describes a wheeled dolly to transport a sander with a hand-operable brake for restraining rotation of at least one of the dolly wheels.

WO 03/106771 (SCHENNACH et al.) describes a soil compacting device that has a wheel assembly integrated directly with the device for transport.

Even though construction workers are provided with devices for carrying heavy tools as shown above, these devices are not always adapted or adaptable to certain types of vibratory plate compactors.

Thus, there is still a need for an apparatus facilitating the transport of a vibratory plate compactor, in a simple, safe, maneuverable and efficient manner, to speed up equipment relocation times, while taking into consideration the variability in the sizes of the plates and different weights of compactors.

### SUMMARY OF THE INVENTION

An object of the present invention is to propose an apparatus that satisfies the above-mentioned need.

According to the present invention, that object is accomplished with a wheeled cart for transporting a tool, the tool having a base plate, the wheeled cart comprising:
a platform supporting the base plate;
a wheel assembly connected to the platform; and
at least one adjustable attach member connected to the platform to removably attach the tool to the platform, the attach member comprising.
   a vertical projecting member extending generally upwardly from the platform; and
   a generally right-angle bracket with a first bracket member directed inwardly toward a center of the platform and a second bracket member removably fastenable to the vertical projecting member at a plurality of longitudinal positions therealong, the attach member further comprising a bracket locking mechanism for locking the second bracket member at a selected one of the longitudinal positions.

As can be appreciated, the wheeled cart according to the present invention can be easily and quickly adjusted to a wide range of plates of compactors.

A non-restrictive description of a preferred embodiment of the invention will now be given with reference to the appended drawings.

### BRIEF DESCRIPTION OF THE DRAWINGS

FIG. 1 is a perspective view of the wheeled cart according to a first preferred embodiment of the present invention;

FIG. 2 is another perspective view of the wheeled cart according to a first preferred embodiment of the present invention;

FIG. 3A is an exploded view of the components of the wheeled cart shown in FIG. 2;

FIG. 3B is a perspective enlarged view of the attach member of the wheeled cart shown in FIG. 3A;

FIG. 4 is another exploded view of the components of the wheeled cart shown in FIG. 2;

FIG. 5 is a perspective view of the wheeled cart of FIG. 1 carrying a vibratory plate compactor.

FIG. 6 is a perspective view of the wheeled cart of FIG. 1 carrying another type of vibratory plate compactor.

FIGS. 7A to 7C illustrate the installation of a cart according to a preferred embodiment of the present invention being installed on a vibrating plate compactor.

FIG. 8 is a perspective view of the wheeled cart according to a second preferred embodiment of the present invention;

FIG. 9 is an exploded view of the components of the wheeled cart shown in FIG. 8;

FIG. 10A is a perspective enlarged view of the attach member of the wheeled cart shown in FIG. 8 in a closed position;

FIG. 10B is a perspective enlarged view of the attach member of the wheeled cart shown in FIG. 8 in an open position;

FIG. 11 is a perspective view of the wheeled cart of FIG. 8 carrying a vibratory plate compactor.

### DESCRIPTION OF PREFERRED EMBODIMENTS

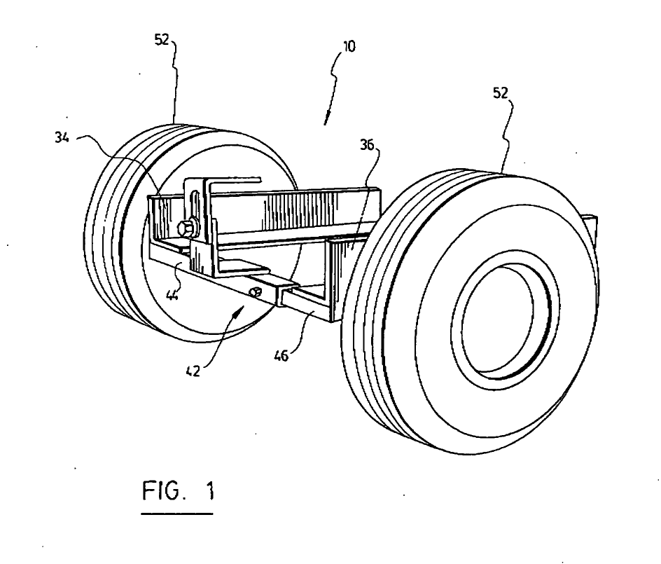

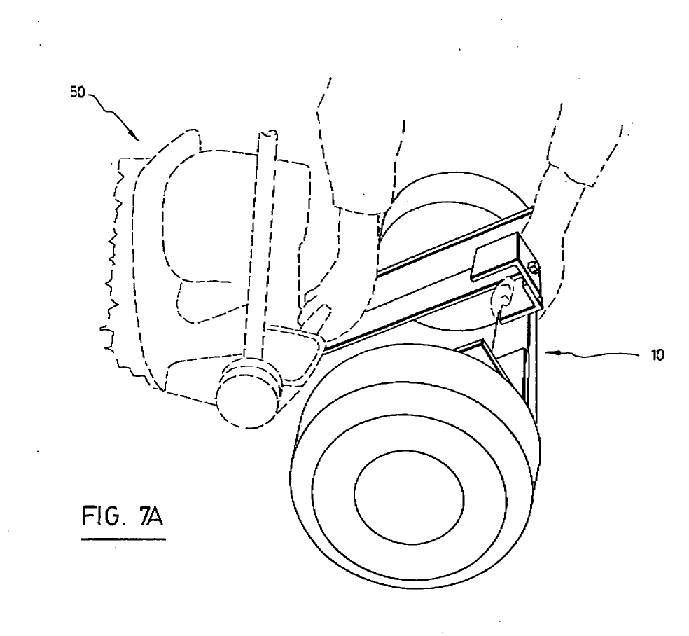

Referring to FIGS. 1 to 11, there is shown a wheeled cart 10 according to preferred embodiments of the present invention. The wheeled cart is suitable for carrying a tool having a base plate.

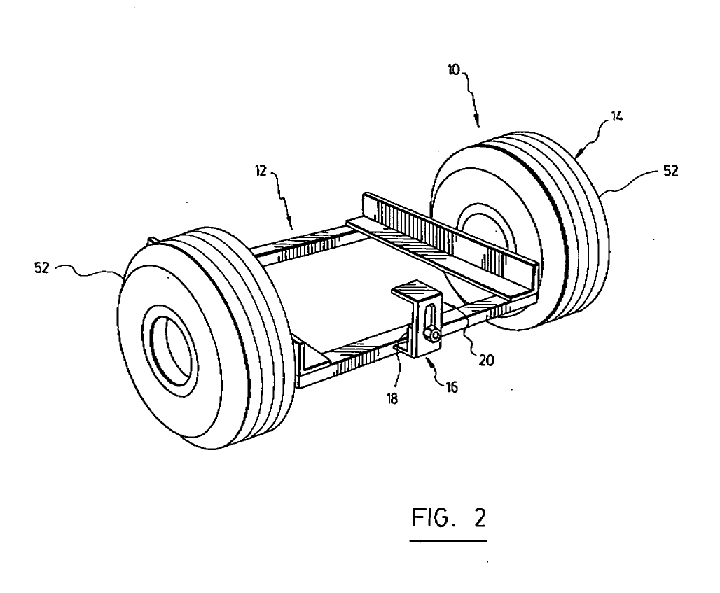

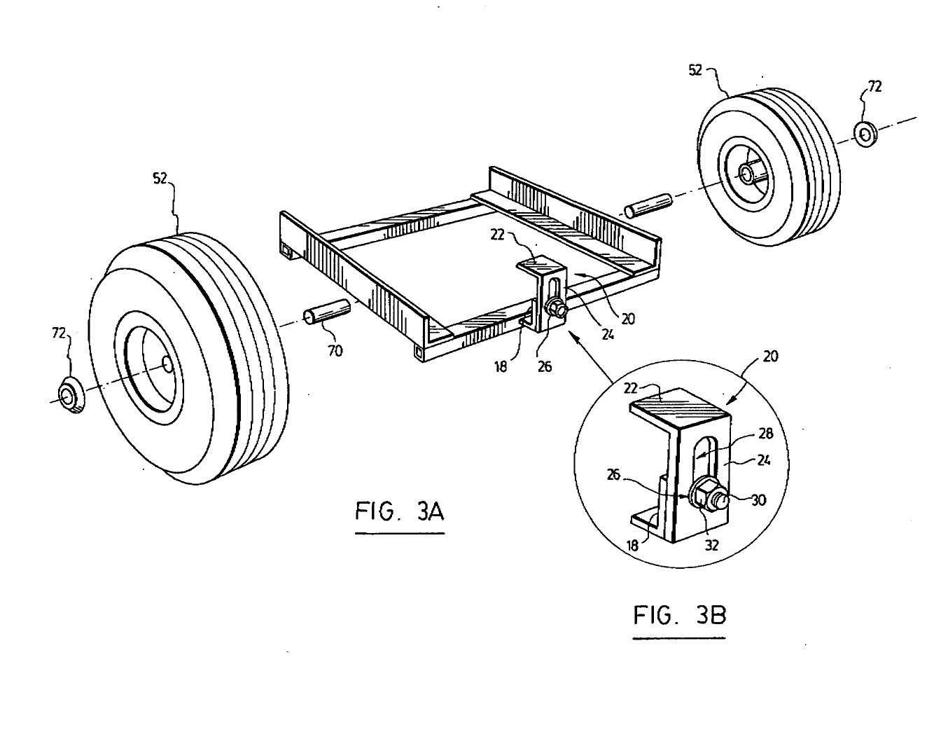

As shown in FIGS. 2, the wheeled cart 10 comprises a platform 12 supporting the base plate and a wheel assembly 14 connected to the platform 12. The cart 10 further comprises at least one adjustable attach member 16 connected to the platform 12 to removably attach the tool to the platform 12. The attach member 16 comprises a vertical projecting member 18 extending generally upwardly from the platform 12, and a generally right-angle bracket 20. As shown in FIGS. 3A and 3B, the bracket 20 has a first bracket member 22 directed inwardly toward a center of the platform and a second bracket member 24 removably fastenable to the vertical projecting member 18 at a plurality of longitudinal positions therealong. The attach member 16 further comprises a bracket locking mechanism 26 for locking the second bracket member 24 at a selected one of the longitudinal positions. This bracket system helps retain the plate of the compactor.

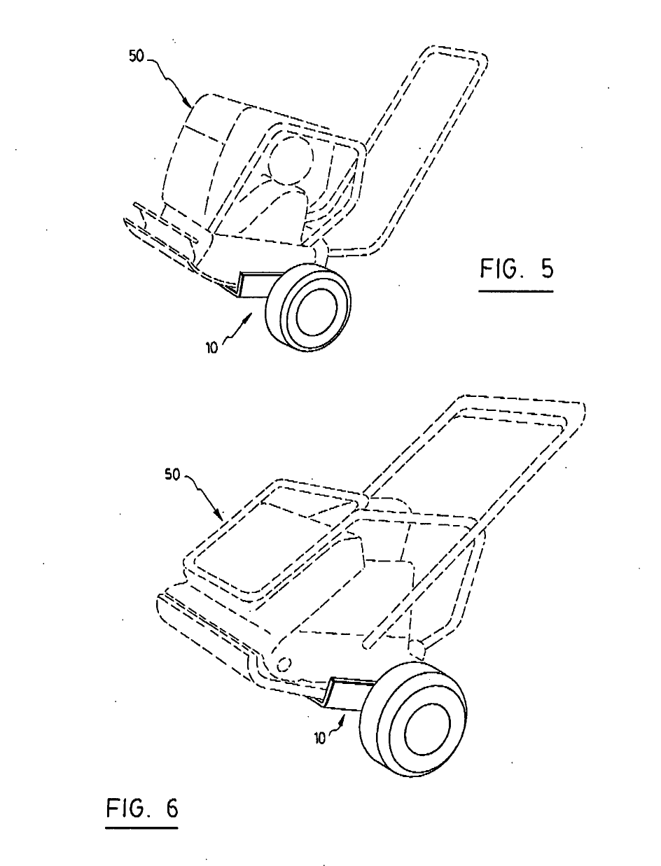

Preferably, as shown in FIGS. 5, 6 or 11, the tool 50 is a vibrating plate compactor.

Preferably, as shown in FIG. 3B, the bracket locking mechanism 26 comprises a slot 28 extending through the second bracket member 24. The mechanism 26 further comprises at least one bolt 30 extending from the vertical projecting member 18 and sized to be accepted through the second bracket member slot 28. The mechanism also comprises at least one nut 32 removably screwed on the bolt 30 to lock the second bracket member 24 at the selected one of the longitudinal positions.

Preferably, components of the cart that are not meant to move one with respect to another are welded together. Other means of assembling components can also be used.

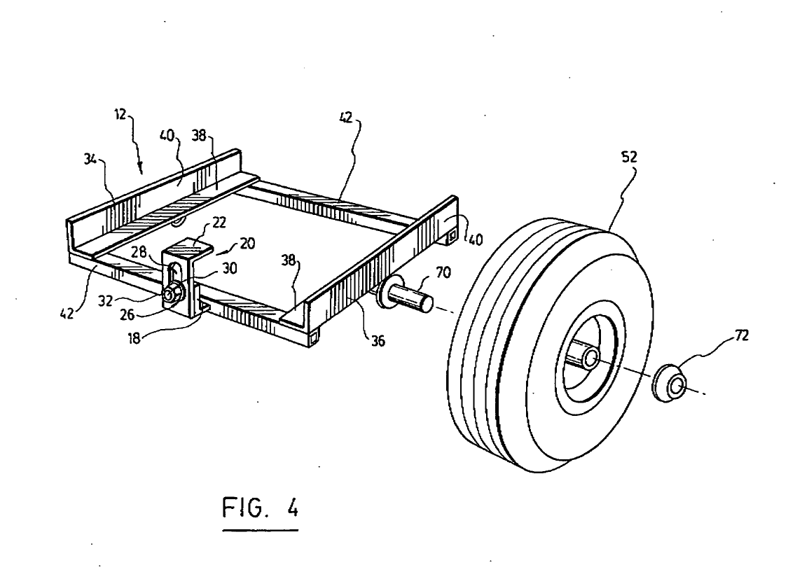

Preferably, as shown in FIG. 4, the platform 12 comprises first 34 and second 36 opposite side arms which are right angle in cross-section, each of the side arms having a lower flange 38 and a vertical upwardly directed flange 40 to keep the plate from sliding laterally. Each lower flange is directed inwardly toward the other lower flange. The platform also comprises a pair of spaced-apart cross-members 42 supporting the first and second opposite side arms 34, 36.

Preferably, as shown in FIG. 1, each cross-member 42 comprises a first support member 44 attached to the first side arm 34 and a second support member 46 attached to the second side arm and removably fastenable to the first support member at a plurality of platform width-setting positions along a length of the first support member. The cross-member 42 further comprises a support member locking mechanism for locking the second support member 46 at a selected one of the platform width-setting positions. This allows the cart to fit different tools having base plates of varying widths as shown in FIGS. 5, 6 and 11.

Preferably, the support member locking mechanism comprises a plurality of first support member fastener holes extending through the length of the first support member at longitudinally offset locations. The mechanism also comprises at least one second support member fastener hole extending through the second support member, each second support member fastener hole being in transversal alignment with at least one of the first support member fastener holes. The mechanism finally comprises at least one fastener sized to be accepted through the first support member and second support member fastener holes to fix the support members 44, 46 at their desired width setting.

Preferably, the plurality of first support member fastener holes form at least one row along the length of the first support member 44.

Preferably, the at least one fastener is selected from the group consisting of screws and rivets.

Preferably, as shown in FIG. 1, the first support member 44 is shaped to slide telescopically with respect to the second support member 46.

Preferably, as shown in FIGS. 1 to 4, the cross-members 42 are substantially square-shaped.

Preferably, the platform 12 is made of a metal selected from the group consisting of steel, aluminum, steel alloys and aluminum alloys.

Preferably, as shown in FIGS. 1 to 4, the wheel assembly 14 comprises a pair of pneumatic wheels 52. The wheels can be attached to axles using caps.

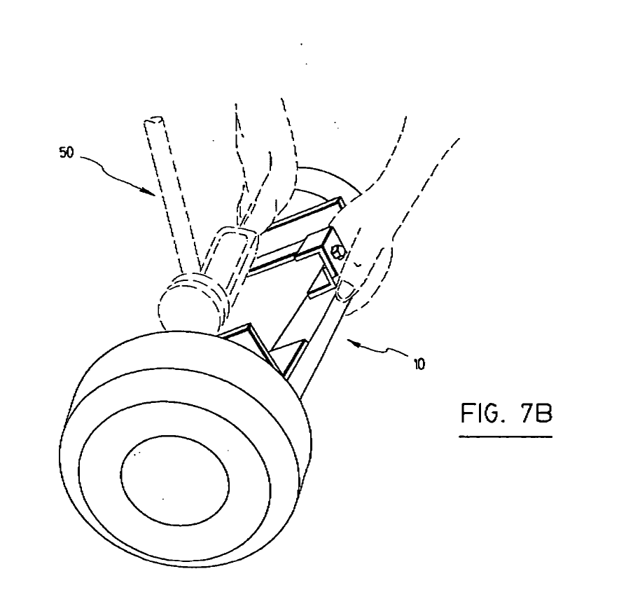

FIGS. 7A to 7C illustrate the installation of a cart 10 according to a preferred embodiment of the present invention being installed on a vibrating plate compactor 50. As shown on FIG. 7C, the attach member 16 is adjusted to fit the bottom base plate 54 of the compactor 50.

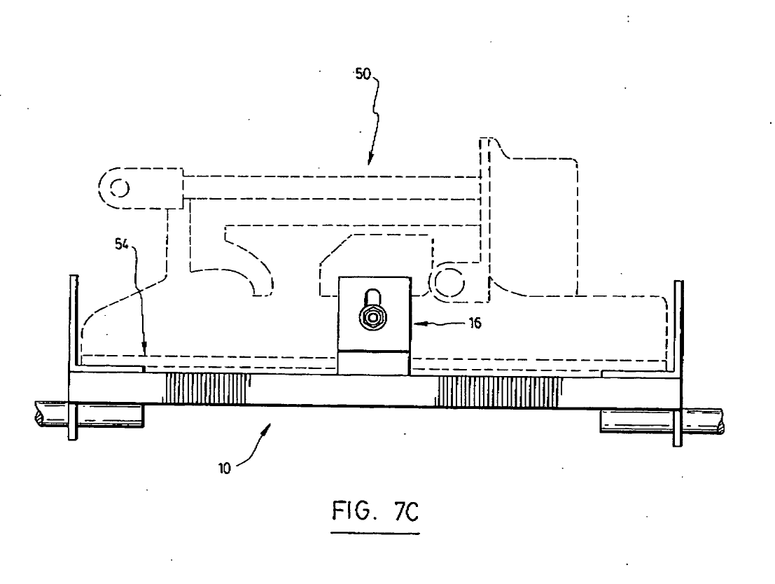

FIGS. 8 to 11 show another preferred embodiment of the present invention. The wheeled cart 10 comprises a platform 12, on which the tool can be laid down, and a wheel assembly 14 operatively connected to the platform 12. The wheeled cart 10 also comprises at least one adjustable attach member 60 to removably attach the tool to the platform 12.

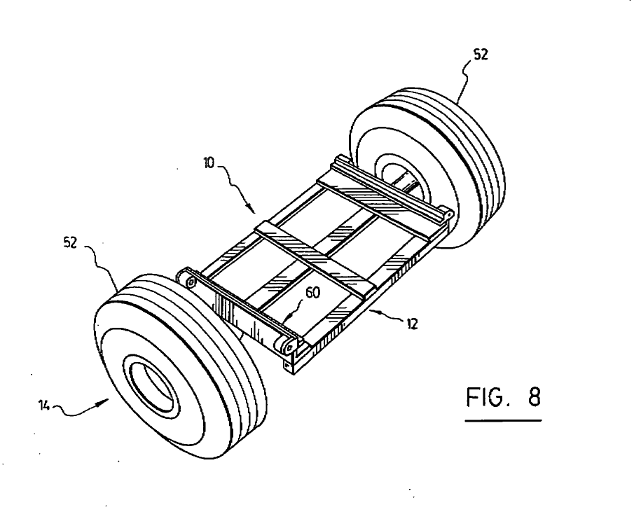

As before and as shown in FIG. 9, the platform 12 comprises two arms 34, 36 and two cross-members 42 preferably made of steel and forming a rectangular base for receiving the plate of a vibratory plate compactor. The two arms 34, 36 are parallel bars having an L-section. The two L-sectioned bars 14 are projecting vertically to keep the plate from sliding laterally. The two other supporting members are parallel square-sectioned cross-members 42.

As shown in FIG. 9, the wheel assembly 14 preferably comprises axles 70 and two wheels 52 having pneumatic tires.

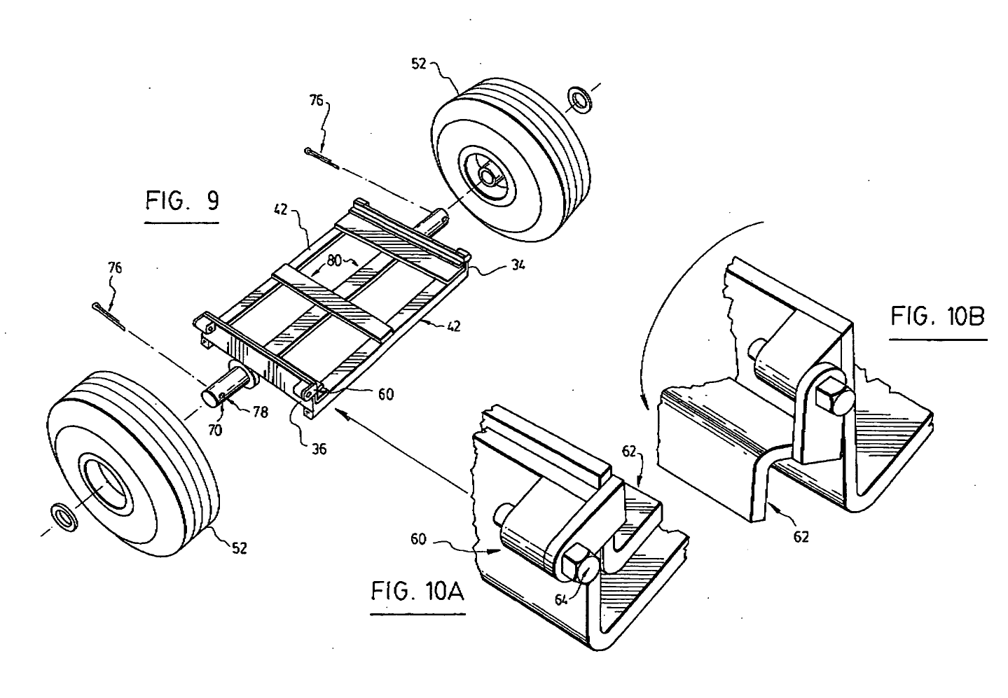

As better shown in FIGS. 10A and 10B, the second type of attach member 60 is preferably a system of two adjustable L-sectioned retaining bars 62. Each of these retaining bars 62 is rotatably mounted on one of the vertical projections of the L-shaped arms 34, 36 of the platform 12 using a nut and bolt system 64. FIG. 10A shows the position of the retaining bar 62 when the attach member is closed in order to retain a compactor plate and FIG. 10B shows the retaining bar 62 open before placing or after removing a plate from a compactor.

Preferably, as shown in FIG. 9, for more strength, the rectangular base of the platform 12 is further provided with two crossing stiffness members 80, preferably along the midperpendicular axis of the platform 12. In this second embodiment, the wheels are attached to the axles 70 using split pins 76 inserted in holes 78 of the axles 70.

Extension of the width of the platform 12 can be accomplished through various mechanisms as described previously, including also having a platform comprising two U-shaped sections, one of the sections having tips that are attached and slide telescopically with respect to the tips of the other U-shaped section. The U-shaped sections can then be positioned with respect to each other to adjust to the size of different tools being transported. The sections can be fixed into position with bolts or other attachment mechanisms. Other such enlargeable platforms can be envisioned.

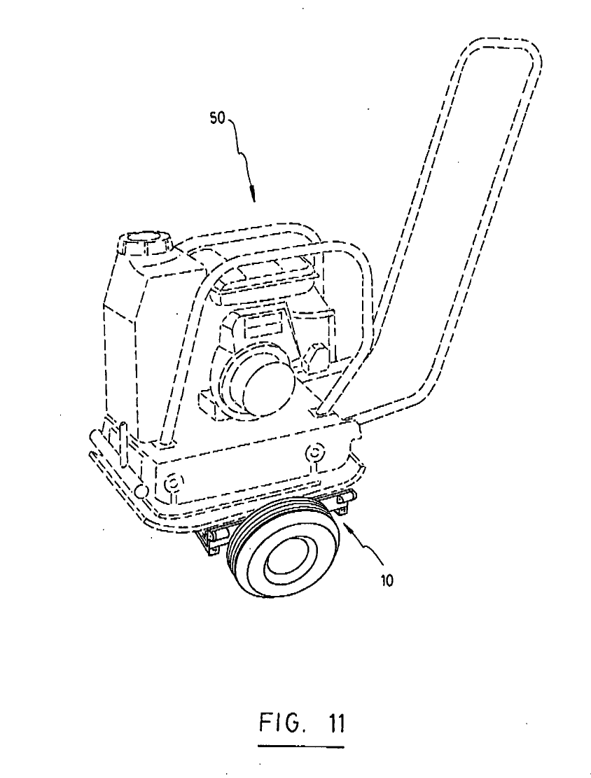

Referring to FIG. 11, the wheeled cart 10 according to the second preferred embodiment of the present invention is shown carrying a vibratory plate compactor 50.

The cart according to the present invention can support weights up to 400 pounds

The following table gives details on dimensions of the components of the wheeled cart according to a preferred embodiment of the invention.

| Identification | Dimension |
|---|---|
| Wheels (Tires) | 10″ on ⅝″ bearing |
| Axles | ⅝″ × 28″ |
| Length of the bars | 12″-14″-16″-18″-20″- |
| | 22″-24″-26″-28″ |
| | (variable setting) |
| Section of the L-sectioned arms | 1′½″ × 1′½″ |
| Section of the of the | ¾″ × ¾″ |
| squared-sectioned cross-members | |

Although the present invention has been explained hereinabove by way of preferred embodiments thereof, it should be pointed out that any modifications to these preferred embodiments within the scope of the appended claims is not deemed to alter or change the nature and scope of the present invention.

What is claimed is:

1. A wheeled cart for transporting a tool, the tool having a base plate, the wheeled cart comprising:
a platform supporting the base plate,
a wheel assembly connected to the platform, and
at least one adjustable attach member connected to the platform to removably attach the tool to the platform, the attach member comprising:
a vertical projecting member extending generally upwardly from the platform; and
a generally right-angle bracket with a first bracket member directed inwardly toward a center of the platform and a second bracket member removably fastenable to the vertical projecting member at a plurality of longitudinal positions therealong, the attach member further comprising a bracket locking mechanism for locking the second bracket member at a selected one of the longitudinal positions.

2. The wheeled cart according to claim 1, wherein the tool is a vibrating plate compactor.

3. The wheeled card according to claim 1, wherein the bracket locking mechanism comprises:
a slot extending through the second bracket member;
at least one bolt extending from the vertical projecting member and sized to be accepted through the second bracket member slot; and
at least one nut removably screwed on the bolt to lock the second bracket member at the selected one of the longitudinal positions.

4. The wheeled cart according to claim 1, wherein the platform comprises:
first and second opposite side arms which are right angle in cross-section, each of the side arms having a lower flange and a vertical upwardly directed flange, each lower flange being directed inwardly toward the other lower flange; and
a pair of spaced-apart cross-members supporting the first and second opposite side arms.

5. The wheeled cart according to claim 4, wherein each cross-member comprises:
a first support member attached to the first side arm;
a second support member attached to the second side arm and removably fastenable to the first support member at a plurality of platform width-setting positions along a length of the first support member; and
a support member locking mechanism for locking the second support member at a selected one of the platform width-setting positions.

6. The wheeled cart according to claim 5, wherein the support member locking mechanism comprises:
a plurality of first support member fastener holes extending through the length of the first support member at longitudinally offset locations;
at least one second support member fastener hole extending through the second support member, each second support member fastener hole being in transversal alignment with at least one of the first support member fastener holes; and
at least one fastener sized to be accepted through the first support member and second support member fastener holes.

7. The wheeled cart according to claim 6, wherein the plurality of first support member fastener holes form at least one row along the length of the first support member.

8. The wheeled cart according to claim 6, wherein the at least one fastener is selected from the group consisting of screws and rivets.

9. The wheeled cart according to claim 5, wherein the first support member is shaped to slide telescopically with respect to the second support member.

10. The wheeled cart according to claim 4, wherein the cross-members are substantially square-shaped.

11. The wheeled cart according to claim 1, wherein the platform is made of a metal selected from the group consisting of steel, aluminum, steel alloys and aluminum alloys.

12. The wheeled cart according to claim 1, wherein the wheel assembly comprises a pair of pneumatic wheels.
